(19) United States
(12) Patent Application Publication
(10) Pub. No.: US 2008/0176662 A1
(43) Pub. Date: Jul. 24, 2008

(54) POWER TRANSMISSION DEVICE FOR VEHICLE AND PRODUCTION METHOD THEREOF

(75) Inventors: Hiroyuki TATENO, Toyota-shi (JP); Kazutoshi Motoike, Okazaki-shi (JP); Masatoshi Adachi, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/015,708

(22) Filed: Jan. 17, 2008

(30) Foreign Application Priority Data
Jan. 18, 2007 (JP) 2007-009081

(51) Int. Cl. F16D 3/12; F16D 1/12; F16C 3/00

(52) U.S. Cl. 464/160; 464/180

(57) ABSTRACT

An output shaft of an internal combustion engine and an input shaft of a transmission are coupled to each other via a damper device. The damper device includes a housing and a rotary member that rotate relative to each other to damp the torsional vibration of the output shaft, and transmits the rotational force of the output shaft to the input shaft and damps the torsional vibration of the output shaft. The rotary member is fitted to a hub from outside. The output shaft is fixed via a flywheel to the housing for rotation together therewith, while the input shaft is fitted in a fitting hole formed in the hub.

### INCORPORATION BY REFERENCE

The disclosure of Japanese Patent Application No. 2007-009081 filed on Jan. 18, 2007 including the specification, drawings and abstract is incorporated herein by reference in its entirety.

### BACKGROUND OF THE INVENTION

1. Field of the Invention

The present invention relates to a power transmission device for a vehicle that transmits the rotational force of an output shaft of an internal combustion engine to an input shaft of a transmission and that includes a damper device that dampens the torsional vibration of the output shaft, and a method of producing such a power transmission device.

2. Description of the Related Art

A conventional power transmission device for a vehicle is described, for example, in Japanese Patent Application Publication No. 2002-181085 (JP-A-2002-181085). Specifically, as shown in FIG. 3, a flywheel 111 is bolted to the flange 110a of an output shaft 110 of an internal combustion engine. Housings 121 and 122 for a damper device 120 are attached to the flywheel 111 by bolts 112. A generally cylindrical hub 123 is inserted in rotation support parts 121a and 122a respectively formed in the center of the housings 121 and 122. The hub 123 is rotatably supported by the rotation support parts 121a and 122a.

A disk-shaped rotary member 124 is fitted on the outer periphery of the hub 123. The rotary member 124 is accommodated in a space defined by the housings 121 and 122. The rotary member 124 rotates together with the hub 123. A friction member 126 is slidably fixed to both sides of the rotary member 124 on the inner surface of the housings 121 and 122. A plurality of accommodation portions 124a are formed in the rotary member 124 extending along the rotational direction of the rotary member 124. A plurality of compressed springs 125 are respectively provided in the accommodation portions 124a. The housings 121 and 122 are respectively formed with a plurality of accommodation portions 121b and 122b corresponding to the springs 125. The inner surfaces of the accommodation portions 121b and 122b at both ends in the rotational direction of the housings 121 and 122 are respectively in contact with both ends of the springs 125. As a result, when the housings 121 and 122 and the rotary member 124 rotate relative to each other, one end of the springs 125 comes into contact with the housings 121 and 122 while the other end comes into contact with the rotary member 124, so that the springs 125 are compressed by the housings 121 and 122 and the rotary member 124.

A through hole 123a is formed in the center of the hub 123 to extend along the direction of the rotational axis of the hub 123. Splines 141 are formed in the side wall of the through hole 123a to also extend along the direction of the rotational axis of the hub 123. Splines 142 for engagement with the splines 141 are formed at the distal end of an input shaft 130 of a transmission 190 of a vehicle. The hub 123 and the input shaft 130 rotate together with each other due to the engagement between the splines 141 and 142.

With the power transmission device described above, when the internal combustion engine is operated, the rotational force of the output shaft 110 is transmitted via the flywheel 111 to the housings 121 and 122. The housings 121 and 122 cause the rotary member 124, the hub 123, and the input shaft 130 to rotate via the springs 125. In the case where torsional vibration of the output shaft 110 occurs, the springs 125 are expanded and compressed to allow the housings 121 and 122 and the rotary member 124 to rotate relative to each other, thus suppressing the intensity of the torsional vibration. When the housings 121 and 122 and the rotary member 124 rotate relative to each other, the friction member 126 slides on the inner surface of the housings 121 and 122. As a result, the vibration energy of the torsional vibration of the output shaft 110 is converted into heat energy, thereby damping the torsional vibration.

In order to produce such a power transmission device, a method disclosed in, for example, Japanese Patent Application Publication No. 06-031033 (JP-A-06-031033) is widely used. This production method includes: after attaching the damper device 120 to the flywheel 111 with the bolts 112, moving the transmission 190 toward the internal combustion engine, and inserting the input shaft 130 into the through hole 123a of the hub 123 to bring the input shaft 130 and the through hole 123a into sliding engagement with each other. In order to smoothly insert the input shaft 130 into the through hole 123a of the hub 123, a predetermined clearance must be provided between the splines 141 and the splines 142.

With the power transmission device described above, it is possible to transmit the rotational force of the output shaft 110 of the internal combustion engine to the input shaft 130 of the transmission 190, and to damp the torsional vibration of the output shaft 110. However, since there is a clearance between the splines 141 and 142 as described above, the relative rotational phase between the hub 123 and the input shaft 130 may change when the rotational speed of the output shaft 110 or the input shaft 130 changes due to, for example, changes in the running state of the vehicle, which may result in a collision between the splines 141 and 142. In the case where an excessively large collision occurs between the splines 141 and 142 due to abrupt changes in the rotational speed of the output shaft 110 or the input shaft 130 when, for example, the internal combustion engine is started, an unignorable abnormal noise may occur, and the durability of the splines 141 and 142, that is, the connection between the input shaft 130 and the hub 123, may be reduced.

### SUMMARY OF THE INVENTION

The present invention provides a power transmission device for a vehicle that suppress the possibility that an abnormal noise occurs in the coupling part between a damper device provided on an output shaft of an internal combustion engine and an input shaft of a transmission, and the possibility that the durability of the coupling part is reduced, due to changes in the running state of the vehicle.

A first aspect of the present invention provides a power transmission device for a vehicle, including: a damper device that couples an output shaft of an internal combustion engine and an input shaft of a transmission to transmit a rotational force of the output shaft to the input shaft and that damps torsional vibration of the output shaft, in which the damper device includes a first rotary member and a second rotary member that rotate relative to each other to damp the torsional vibration, and one of the output shaft and the input shaft is fixed to the first rotary member for rotation together therewith and the other is fitted in a fitting hole formed in the second rotary member.

According to the above construction, one of the output shaft of the internal combustion engine and the input shaft of the transmission is fixed to the first rotary member of the damper device for rotation together therewith, while the other is fitted in the fitting hole formed in the second rotary member of the damper device. Hence, relative rotation between the fitting hole and the output shaft or the input shaft can be suppressed even in the case where the rotational speed of the output shaft of the internal combustion engine or the input shaft of the transmission changes due to, for example, changes in the running state of the vehicle. Therefore, it is possible to suppress the possibility that an abnormal noise occurs in the coupling part between the damper device provided on the output shaft of the internal combustion engine and the input shaft of the transmission, and the possibility that the durability of the coupling part is reduced, due to changes in the running state of the vehicle, unlike in the case where the rotational force is transmitted by engagement of splines having a clearance therebetween.

In the first embodiment, the output shaft may be fixed to the first rotary member for rotation together therewith while the input shaft is fitted in the fitting hole formed in the second rotary member, and a first spline may be formed on an outer periphery of the input shaft and extends in an axial direction thereof while a second spline for engagement with the first spline is formed on a side wall of the fitting hole formed in the second rotary member.

In the case where a cylindrical input shaft is fitted in a circular fitting hole formed in the rotary member of the damper device, for example, the rotational force must be transmitted between the rotary member and the input shaft by only the stationary friction force between the side wall of the fitting hole and the outer peripheral surface of the input shaft. Therefore, the rotary member and the input shaft may rotate relative to each other, and the damper device may not be able to transmit the rotational force, when the rotational force to be transmitted by the damper device exceeds the maximum value of the stationary friction force between the side wall of the fitting hole and the outer peripheral surface of the input shaft. As the rotary member is fitted to the input shaft more tightly, the maximum value of the stationary friction force, in other words, the maximum value of the rotational force that can be transmitted by the damper device, becomes larger, while the step of fitting the rotary member to the input shaft becomes more difficult.

According to the above construction, since the first spline is formed on the outer periphery of the input shaft to extend along the axial direction thereof while the second spline for engagement with the first spline is formed on the side wall of the fitting hole formed in the second rotary member, it is possible to suppress relative rotation between the input shaft and the second rotary member with the splines engage each other. Therefore, it is possible to easily increase the maximum value of the rotational force that can be transmitted by the damper device, compared to the case where, for example, a cylindrical input shaft is fitted in a circular fitting hole formed in the rotary member.

In the first embodiment, the transmission may be a hybrid transmission that splits the rotational force transmitted to the input shaft between an energy conversion mechanism and a driving wheel of the vehicle based on a running state of the vehicle through a power split mechanism which is mechanically connected to the input shaft.

In a power transmission device for a vehicle adopting a hybrid transmission, the rotational force transmitted to the input shaft of the transmission is appropriately split between the energy conversion mechanism such as a generator and the driving wheel based on the running state of the vehicle by the power split mechanism mechanically connected to the input shaft. A mechanism for transmitting torque via a fluid, such as a torque converter for use in an automatic transmission, is not connected to the input shaft of the hybrid transmission, and hence vibration of the input shaft cannot be absorbed by such a mechanism. Therefore, in the case where the damper device and the input shaft of the transmission are coupled by sliding engagement of the input shaft and the fitting hole formed in the rotary member of the damper device in the power transmission device for a vehicle adopting a hybrid transmission, the possibility that an abnormal noise occurs in the coupling part between the damper device and the input shaft of the transmission, and the possibility that the durability of the coupling part is reduced, become more serious. Moreover, an electronic control unit for performing various controls is provided to the power transmission device for a vehicle adopting a hybrid transmission, and the internal combustion engine is started and stopped by the electronic control unit based on the running state of the vehicle. In the case where the internal combustion engine is started and stopped without the driver being aware of it, and an abnormal noise occurs at the coupling part between the damper device and the input shaft of the transmission, a great discomfort may be given to the driver.

According to the above construction, in which a hybrid transmission is adopted, it is possible to suitably suppress the possibility that an abnormal noise occurs in the coupling part between the damper device and the input shaft of the transmission, and the possibility that the durability of the coupling part is reduced. In addition, even in the case where the internal combustion engine is started and stopped based on the running state of the vehicle without awareness of the driver, it is possible to suppress the possibility that a discomfort is given to the driver by an abnormal noise.

A second embodiment of the present invention provides a method of producing a power transmission device for a vehicle, the power transmission device including a damper device that couples an output shaft of an internal combustion engine and an input shaft of a transmission to transmit a rotational force of the output shaft to the input shaft and that damps torsional vibration of the output shaft, the method including: connecting a first rotary member and a second rotary member, which rotate relative to each other to damp the torsional vibration, to the damper device; fitting one of the output shaft and the input shaft into a fitting hole formed in the second rotary member; and fixing the other of the output shaft and the input shaft to the first rotary member for rotation together therewith after the fitting of one of the output shaft and the input shaft.

According to the above method, the power transmission device for a vehicle in accordance with the first aspect can be produced. The steps of the production can be simplified by fitting one of the output shaft and the input shaft into the fitting hole formed in the second rotary member, and then fixing the other to the first rotary member for rotation together therewith, compared to the case where, for example, one of the output shaft and the input shaft is first fixed to the first rotary member for rotation together therewith, and the other is then fitted into the fitting hole formed in the second rotary member by moving the internal combustion engine or the transmission.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram showing the schematic construction of a power transmission device for a vehicle in accordance with an embodiment of the present invention;

FIG. 2 is a sectional view showing the detailed structure of a damper device in accordance with the embodiment of the present invention and how it is attached; and

FIG. 3 is a sectional view showing the detailed structure of a damper device of a conventional power transmission device for a vehicle and how it is attached.

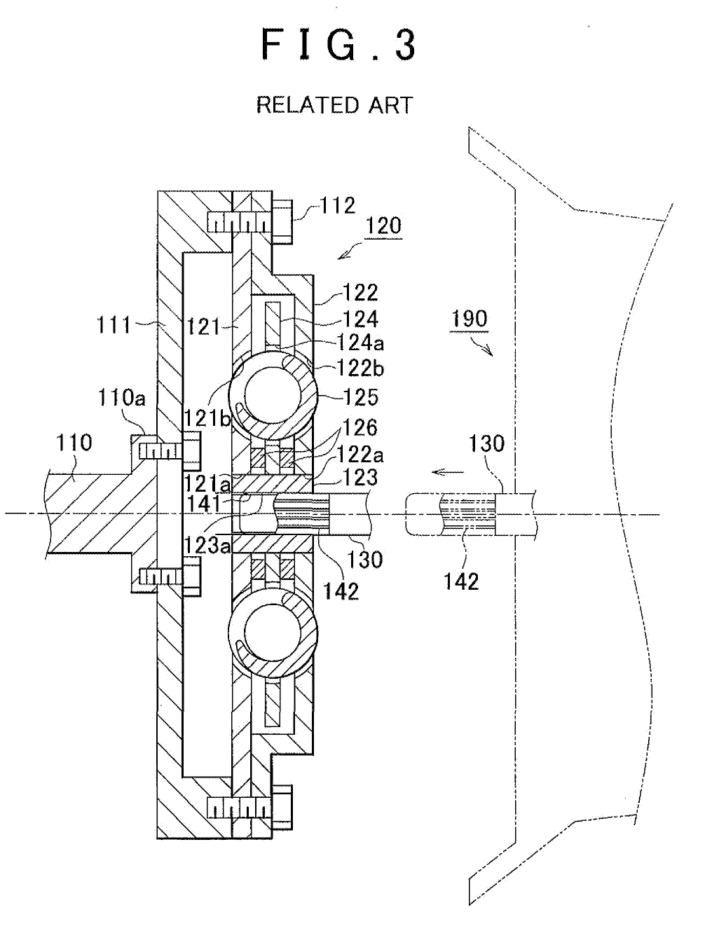

### DETAILED DESCRIPTION OF EMBODIMENTS

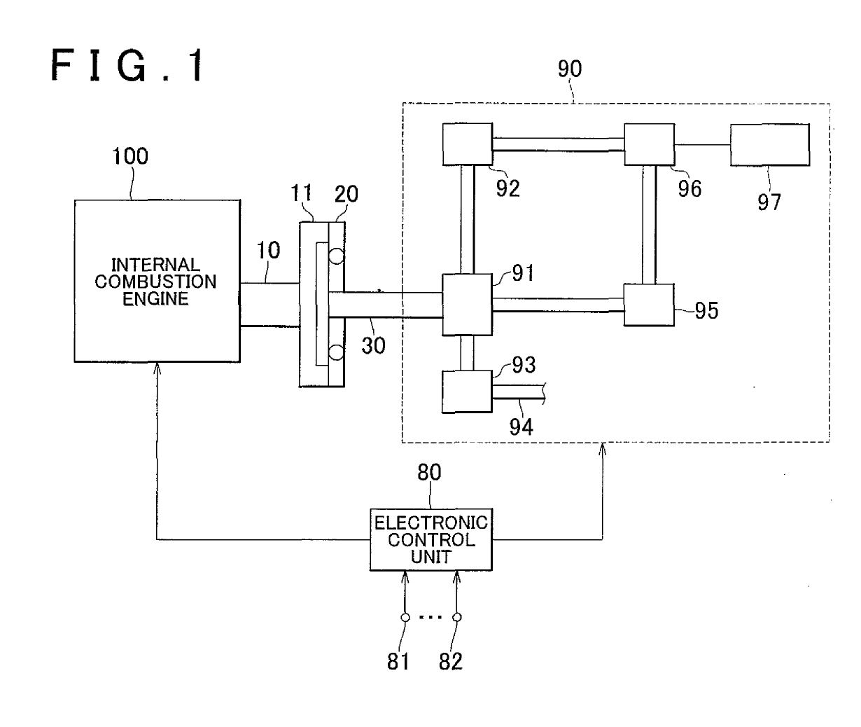

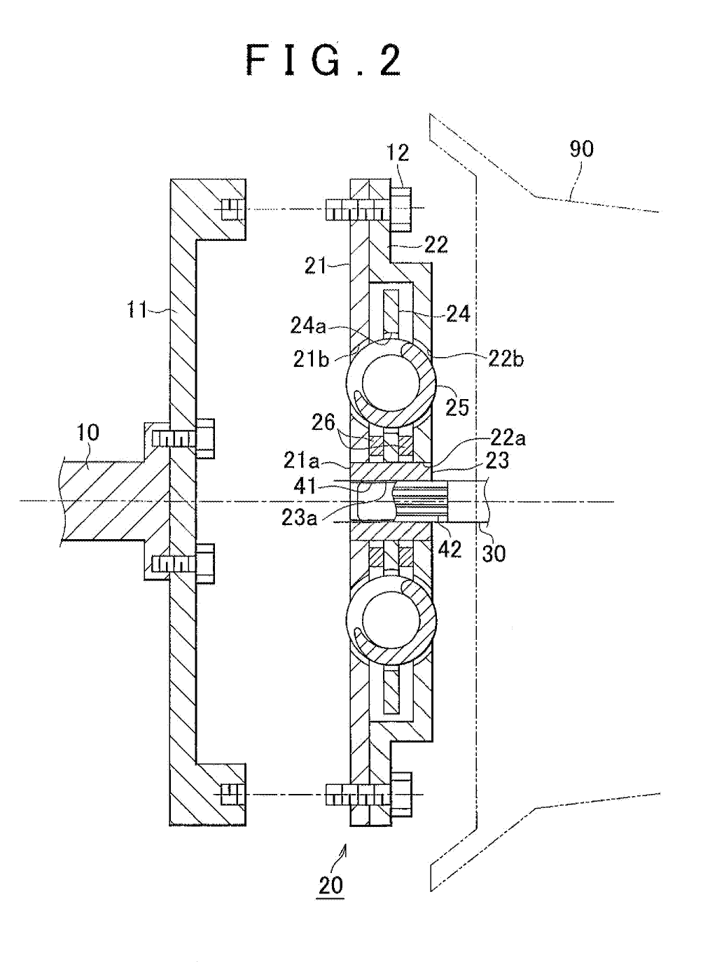

An embodiment in which a power transmission device for a vehicle in accordance with the present invention is applied to a hybrid vehicle will be described below with reference to FIGS. 1 and 2. As shown in FIG. 1, in the power transmission device in accordance with this embodiment, a flywheel 11 is fixed to an output shaft 10 of an internal combustion engine 100. The flywheel 11 is coupled to an input shaft 30 of a hybrid transmission 90 via a damper device 20.

A power split mechanism 91 is mechanically coupled to the input shaft 30. A generator 92, which functions as an energy conversion mechanism, and a gear change mechanism 93 are coupled to the power split mechanism 91. The gear change mechanism 93 is coupled to a driving wheel of the vehicle via a drive shaft 94 and so forth. The power split mechanism 91 splits the rotational force transmitted from the output shaft 10 of the internal combustion engine 100 to the input shaft 30 into two paths. That is, the rotational force of the input shaft 30 is transmitted directly to the drive shaft 94 via the gear change mechanism 93 to be utilized to drive the driving wheel of the vehicle, and also transmitted to the generator 92 to be utilized by the generator 92 to generate AC power. The AC power generated by the generator 92 is converted into DC power by an inverter 96 to be charged into a battery 97. An electric motor 95 is connected to the inverter 96. The DC power in the battery 97 is converted into AC power via the inverter 96 to be utilized to drive the electric motor 95. The driving force of the electric motor 95 is transmitted via the power split mechanism 91 to the drive shaft 94.

An electronic control unit 80 that performs various controls is provided for the power transmission device. A vehicle speed sensor 81 for detecting the vehicle speed and an accelerator sensor 82 for detecting the accelerator opening degree are connected to the electronic control unit 80. The electronic control unit 80 chooses an appropriate power transmission mode by controlling the operating state of the internal combustion engine 100, the operating state of the electric motor 95, and so forth based on the running state of the vehicle detected by these sensors.

For example, when the vehicle moves under a low load, in order to reduce fuel consumption, the internal combustion engine 100 is stopped and the battery 97 discharges electricity to drive the vehicle using the electric motor 95, and the driving force of the electric motor 95 is transmitted via the power split mechanism 91 and the gear change mechanism 93 to the drive shaft 94. In contrast, when the vehicle moves under a high load, in order to obtain sufficient power, the internal combustion engine 100 is started and the battery 97 discharges electricity to drive the vehicle using the internal combustion engine 100 in conjunction with the electric motor 95. The rotational force of the internal combustion engine 100, transmitted to the input shaft 30, and the driving force of the electric motor 95 are transmitted via the power split mechanism 91 and the gear change mechanism 93 to the drive shaft 94. When the battery 97 needs to be charged, the internal combustion engine 100 is started and the rotational force transmitted to the input shaft 30 is transmitted via the power split mechanism 91 to the generator 92 so that the generator 92 starts generating electricity to charge the battery 97.

If the damper device 20 and the input shaft 30 of the transmission 90 are coupled by engagement of splines having a clearance therebetween as described above, for example, an abnormal noise may occur in the coupling part between the damper device 20 and the input shaft 30, and the durability of the coupling part may be reduced, when the operating state of the internal combustion engine 100 changes based on changes in the running state of the vehicle.

In the power transmission device for a vehicle in which the hybrid transmission 90 of this embodiment is adopted, a mechanism for transmitting torque via a fluid, such as a torque converter for use in an automatic transmission, is not connected to the input shaft of the transmission, and hence vibration of the input shaft cannot be absorbed by such a mechanism. Therefore, when the damper device 20 and the input shaft 30 of the transmission 90 are coupled by engagement of splines having a clearance therebetween, the possibility that an abnormal noise occurs in the coupling part between the damper device 20 and the input shaft 30 of the transmission 90, and the possibility that the durability of the coupling part is reduced, become more serious. Moreover, because the internal combustion engine 100 is started and stopped by the electronic control unit 80 based on the running state of the vehicle as described above in the power transmission device, the internal combustion engine 100 may be started and stopped without the driver being aware of it. If an abnormal noise occurs in the coupling part between the damper device 20 and the input shaft 30 at such times, a great discomfort may be given to the driver.

In view of the above, this embodiment adopts a construction that suitably suppresses such possibilities. This construction will be described below with reference to FIG. 2. FIG. 2 is a sectional view showing the detailed structure of the damper device 20 and how it is attached. As shown in FIG. 2, in the damper device 20, a generally cylindrical hub 23 is inserted in rotation support parts 21a and 22a respectively formed in the center of housings 21 and 22. The hub 23 is rotatably supported by the rotation support parts 21a and 22a. A disk-shaped rotary member 24 is fitted on the outer periphery of the hub 23. The rotary member 24 is accommodated in a space defined by the housings 21 and 22. The rotary member 24 is rotatable together with the hub 23. A friction member 26 is slidably fixed to both sides of the rotary member 24 on the inner surface of the housings 21 and 22, and functions in the same manner as a conventional damper device.

A plurality of accommodation portions 24a are formed in the rotary member 24 to extend along the rotational direction of the rotary member 24. A plurality of compressed springs 25 are respectively provided in the accommodation portions 24a. The housings 21 and 22 are respectively formed with a plurality of accommodation portions 21b and 22b corresponding to the springs 25. The inner surfaces of the accommodation portions 21b and 22b at both ends in the rotational direction of the housings 21 and 22 are respectively in contact with both ends of the springs 25. When the housings 21 and 22 and the rotary member 24 rotate relative to each other, one end of the springs 25 comes into contact with the housings 21 and 22 while the other end comes into contact with the rotary member 24, so that the springs 25 are compressed by the housings 21 and 22 and the rotary member 24.

A fitting hole 23a is formed in the center of the hub 23, and extends along the direction of the rotational axis of the hub 23. Splines 41 are formed in the side wall of the fitting hole 23a, and extend along the direction of the rotational axis of the hub 23. Splines 42, which tightly engage the splines 41, are formed at the distal end of the input shaft 30 of the transmission 90. The input shaft 30 is press-fitted into the fitting hole 23a so that the hub 23 and the input shaft 30 rotate together. The housings 21 and 22 are fixed by bolts 12 to the flywheel 1, attached to the output shaft 10 of the internal combustion engine 100, so that the housings 21 and 22 rotate together with the flywheel 11 and the output shaft 10.

With the power transmission device described above, when the internal combustion engine is operated, the rotational force of the output shaft 10 is transmitted via the flywheel 11 to the housings 21 and 22. The housings 21 and 22 cause the rotary member 24, the hub 23, and the input shaft 30 to rotate via the springs 25. If torsional vibration of the output shaft 10 occurs, the springs 25 are expanded and compressed to allow the housings 21 and 22 and the rotary member 24 to rotate relative to each other, thus suppressing the intensity of the torsional vibration. When the housings 21 and 22 and the rotary member 24 rotate relative to each other, the friction member 26 slides on the inner surface of the housings 21 and 22. As a result, the vibration energy of the torsional vibration of the output shaft 10 is converted into heat energy, thereby damping the torsional vibration.

A method of producing such a power transmission device includes the following steps [1] to [3]:[1] fitting the rotary member 24 to the hub 23 from outside and assembling these to the housings 21 and 22 of the damper device 20; [2] Press-fitting the input shaft 30 of the transmission 90 into the fitting hole 23a formed in the hub 23; and [3] after completion of the [2] step, assembling the housings 21 and 22 to the flywheel 11 by the bolts 12 to fix the output shaft 10 of the internal combustion engine 100 to the housings 21 and 22 via the flywheel 11 for rotation together with the housings 21 and 22.

According to the embodiment described above, the following effects can be obtained. (1) Because the output shaft 10 of the internal combustion engine 100 is fixed to the housings 21 and 22 of the damper device 20 via the flywheel 11, and rotate with the housings 21 and 22, and the input shaft 30 of the transmission 90 is fitted in the fitting hole 23 a formed in the hub 23 of the damper device 20, relative rotation between the fitting hole 23a and the input shaft 30 can be suppressed even if the rotational speed of the output shaft 10 of the internal combustion engine 100 or the input shaft 30 of the transmission 90 changes due to, for example, changes in the running state of the vehicle. Therefore, it is possible to reduce the possibility that an abnormal noise occurs in the coupling between the damper device 20 provided on the output shaft 10 of the internal combustion engine 100 and the input shaft 30 of the transmission 90, and the possibility that the durability of the coupling part is reduced, due to changes in the running state of the vehicle, unlike in the case where the rotational force is transmitted by engagement of splines having a clearance therebetween. In addition, even if the internal combustion engine 100 is started and stopped based on the running state of the vehicle without awareness of the driver, it is possible to reduce the possibility that a discomfort is given to the driver by an abnormal noise.

(2) Because the splines 41 are formed in the side wall of the fitting hole 23a to extend along the direction of the rotational axis of the hub 23, while the splines 42 for tight engagement with the splines 41 are formed on the periphery of the input shaft 30, it is possible to suppress relative rotation between the input shaft 30 and the hub 23 when the splines 41 and 42 are engaged. Therefore, it is possible to easily increase the maximum rotational force that can be transmitted by the damper device 20, compared to the case where, for example, a cylindrical input shaft is fitted in a circular fitting hole formed in the hub.

Also the above embodiment may be modified appropriately as described below. As described above, the splines 41 and 42 are respectively formed in the side wall of the fitting hole 23a and on the periphery of the input shaft 30, and the input shaft 30 is fitted into the fitting hole 23a with the splines 41 and 42 engage each other. However, the present invention is not limited thereto. For example, an engagement projection may be formed on the input shaft 30, while a corresponding recess may be formed in the side wall of the fitting hole 23a, so that the engagement projection engages the recess when the input shaft 30 is fitted into the fitting hole 23a. If there is an extremely small possibility that the rotational force transmitted between the hub 23 and the input shaft 30 will exceed the maximum value of the stationary friction force between the hub 23 and the input shaft 30 while the vehicle is operated, for example, the input shaft of the transmission 90 having a cylindrical shape may be fitted into the fitting hole having a circular cross section and formed in the hub 23.

In the above embodiment, the output shaft 10 of the internal combustion engine 100 is fixed to the housings 21 and 22 of the damper device 20 via the flywheel 11 and rotates together with the housings 21 and 22, and the input shaft 30 of the transmission 90 is fitted in the fitting hole 23a formed in the hub 23 of the damper device 20. Alternatively, the input shaft of the transmission may be fixed, for example, to the housings 21 and 22 of the damper device via a coupling member or the like and rotate together with the housings 21 and 22, and the output shaft of the internal combustion engine may be fitted in the fitting hole formed in the hub of the damper device.

In the described embodiment, the disk-shaped rotary member 24 is fitted to the periphery of the hub 23 from outside. However, the hub 23 and the rotary member 24 may be formed integrally with each other.

The damper device is not limited to the construction described in the above embodiment. Any suitable construction may be used, as long as it includes a first rotary member and a second rotary member that rotate relative to each other to damp torsional vibration. For example, one of the output shaft 110 of the internal combustion engine 100 and the input shaft 30 of the transmission 90 may be fixed to the first rotary member for rotation together therewith, while the other may be fitted in the fitting hole formed in the second rotary member.

In the above embodiment, the present invention is applied to a power transmission device for a vehicle including the hybrid transmission 90 in which the rotational force transmitted to the input shaft 30 is split between the generator 92 and the driving wheel of the vehicle based on the running state of the vehicle by the power split mechanism 91 mechanically connected the input shaft 30. The present invention is not limited thereto. For example, the present invention may be applied, in a basically similar embodiment, to a power transmission device including various types of transmission, such as an automatic transmission using a torque converter or the like coupled to the input shaft to transmit power transmitted to the input shaft to the driving wheel of the vehicle.

What is claimed is:

1. A power transmission device for a vehicle, comprising:
a damper device that couples an output shaft of an internal combustion engine and an input shaft of a transmission to transmit a rotational force of the output shaft to the input shaft and that damps torsional vibration of the output shaft, wherein the damper device includes a first rotary member and a second rotary member that rotate relative to each other to damp the torsional vibration, and one of the output shaft and the input shaft is fixed to the first rotary member for rotation together therewith while the other is fitted in a fitting hole formed in the second rotary member.

2. The power transmission device according to claim 1, wherein the output shaft is fixed to the first rotary member for rotation together therewith while the input shaft is fitted in the fitting hole formed in the second rotary member, and a first spline is formed on an outer periphery of the input shaft and extends in an axial direction thereof while a second spline for engagement with the first spline is formed on a side wall of the fitting hole formed in the second rotary member.

3. The power transmission device according to claim 1, wherein the input shaft is fixed to the first rotary member for rotation together therewith while the output shaft is fitted in the fitting hole formed in the second rotary member, and a first spline is formed on an outer periphery of the output shaft and extends in an axial direction thereof while a second spline for engagement with the first spline is formed on a side wall of the fitting hole formed in the second rotary member.

4. The power transmission device according to claim 1, wherein the transmission is a hybrid transmission that splits the rotational force transmitted to the input shaft between an energy conversion mechanism and a driving wheel of the vehicle based on a running state of the vehicle through a power split mechanism that is mechanically connected to the input shaft.

5. The power transmission device according to claim 1, wherein a first engagement part is formed on the outer periphery of one of the output shaft and the input shaft that is to be fitted in the fitting hole, and a second engagement part for engagement with the first engagement part is formed on the side wall of the fitting hole.

6. The power transmission device according to claim 5, wherein the first engagement part is a first spline that extends along the axial direction of one of the output shaft and the input shaft, and the second engagement part is a second spline that engages the first spline.

7. The power transmission device according to claim 5, wherein the first engagement part is an engagement projection, and the second engagement part is an engagement recess that engages the engagement projection.

8. A method of producing a power transmission device for a vehicle, the power transmission device including a damper device that couples an output shaft of an internal combustion engine and an input shaft of a transmission to transmit a rotational force of the output shaft to the input shaft and that damps torsional vibration of the output shaft, the method comprising:
connecting a first rotary member and a second rotary member, which rotate relative to each other to damp the torsional vibration, to the damper device;
fitting one of the output shaft and the input shaft into a fitting hole formed in the second rotary member; and
fixing the other of the output shaft and the input shaft to the first rotary member for rotation together therewith after the fitting of one of the output shaft and the input shaft.
